(19) United States
(12) Patent Application Publication
(10) Pub. No.: US 2017/0164048 A1
(43) Pub. Date: Jun. 8, 2017

(54) METHOD AND ELECTRONIC DEVICE FOR IMPLEMENTING QUICK START PLAYING OF VIDEO

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Fei WANG, Beijing (CN); Rui ZHANG, Beijing (CN)

(21) Appl. No.: 15/244,969

(22) Filed: Aug. 23, 2016

Related U.S. Application Data
(63) Continuation of application No. PCT/CN2016/088934, filed on Jul. 6, 2016.

(30) Foreign Application Priority Data
Dec. 7, 2015 (CN) 201510887728.5

(51) Int. Cl. H04N 21/44; G11B 27/34; H04N 21/458; G11B 27/36; H04N 21/442; H04N 21/2343

(52) U.S. Cl. CPC H04N 21/44008; H04N 21/44209; H04N 21/2343; H04N 21/4586; G11B 27/36; G11B 27/34

(57) ABSTRACT

Methods and electronic devices for implementing quick start playing of video are disclosed. An illustrative method may include receiving a trigger instruction of opening a video application, and extracting a playing record of a video file of a user, calculating a quantity of playing the video file at each of resolutions in the playing record to analyze which resolution the user is inclined to use, calculating a quantity of skipping or not skipping a head leader and/or a tail leader in the playing record to analyze whether the user is inclined to skip the head leader and/or the tail leader, and receiving a trigger instruction of clicking the video file and playing the video file according to results of such analysis, such as which resolution the user is inclined to use, whether the user is inclined to skipping the head leader and/or the tail leader, and the like.

### CROSS-REFERENCE TO RELATED APPLICATIONS

This application is a continuation of International PCT patent application No. PCT/CN2016/088934 filed on Jul. 6, 2016 (attached hereto as an Appendix), and claims priority to Chinese Patent Application No. 201510887728.5,entitled “METHOD AND SYSTEM FOR IMPLEMENTING QUICK START PLAYING OF VIDEO”, filed with the State Intellectual Property Office of China on Dec. 7, 2015, all of which are incorporated herein by reference in entirety.

### BACKGROUND

Technical Field

The present disclosure relates to the field of media transmission technology, and particularly to a method and electronic device for implementing quick start playing of video.

Description of Related Information

With rapid development of network technologies, people's requirements for network are reflected in every aspect of life, and network technology starts to have a far-reaching impact on the society. With the development of multimedia technology, the multimedia technology is increasingly widely used in watching videos.

At present, in the network video industry, there are various video application platforms used for providing video services for user. However, in the existing video network application, after clicking a video file on a page displaying video file information to enter a playing page of the video file, a user needs to wait for a lot of time to start playing the video file on the playing page. Therefore, the user needs to wait for a comparatively long period of time from clicking the video file to start watching the video file, and thus the user experience is very poor.

### OVERVIEW OF SOME ASPECTS

In view of this, an object of the present disclosure is to provide a method and electronic device for implementing quick start playing of video, which solve a problem that a comparatively long period of time is required from clicking a video file to playing the video file on a video application platform.

According to a first aspect of embodiments of the disclosure, there is provided a method for implementing quick start playing of video, which includes the following steps:

receiving a trigger instruction of opening a video application and extracting a playing record of a video file of a user;

calculating the number of times of playing the video file at each of resolutions in the playing record to analyze which resolution the user is inclined to use, and calculating the number of times of skipping or not skipping a head leader and a tail leader in the playing record to analyze whether the user is inclined to skip the head leader and the tail leader; and

receiving a trigger instruction of clicking the video file, and playing the video file according to results of analyzing which resolution the user is inclined to use and whether the user is inclined to skip the head leader and the tail leader.

According to a second aspect of embodiments of the present disclosure, there is provided a non-transitory computer-readable storage medium storing executable instructions that, when executed by an electronic device with a touch-sensitive display, cause the electronic device to perform any one of the above methods for implementing quick start playing of video.

According to a third aspect of embodiments of the present disclosure, there is provided an electronic device including one or more processors and a memory for storing instructions executable by the one or more processors, wherein execution of the instructions by the one or more processors causes the one or more processors to perform any one of the above methods for implementing quick start playing of video.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart of a method for implementing quick start playing of video according to a first embodiment of the present disclosure;

FIG. 2 is a schematic flowchart of a method for implementing quick start playing of video according to a referable embodiment of the present disclosure; and

FIG. 3 is a schematic structural diagram of a system for implementing quick start playing of video according to another embodiment of the present disclosure;

FIG. 4 is a schematic structure diagram of hardware of an electronic device for implementing quick start playing of video according to another embodiment of the present disclosure.

### DETAILED DESCRIPTION OF ILLUSTRATIVE IMPLEMENTATIONS

Here, exemplary embodiments will be described in detail, examples of which are illustrated in the accompanying drawings. The following description refers to the accompanying drawings in which the same numbers in different drawings represent the same or similar elements, unless otherwise indicated. The implementations set forth in the following description of exemplary embodiments do not represent all implementations consistent with the present disclosure. Instead, they are merely examples of apparatuses and methods consistent with some aspects of the present disclosure as detailed in the appended claims.

In order to make the objects, technical solutions and advantages of the present disclosure clearer, the present disclosure will be further described in detail below in connection with the embodiments with reference to accompanying drawings.

According to application situation of a multimedia platform, a user needs to wait for a period of time to begin to watch a video file after clicking the video file. This causes that the user wastes a lot of time in waiting for playing of video file, making the user feel disgust, and leading to a very poor user experience. To solve this problem, in the present disclosure, it is realized from the perspective of a user that the user expects to quickly play a video file when clicking the video file. Therefore, an idea of the present disclosure is that a mode for playing a video file is forecasted when a video application platform is opened and the video file can be quickly played when the video file is clicked.

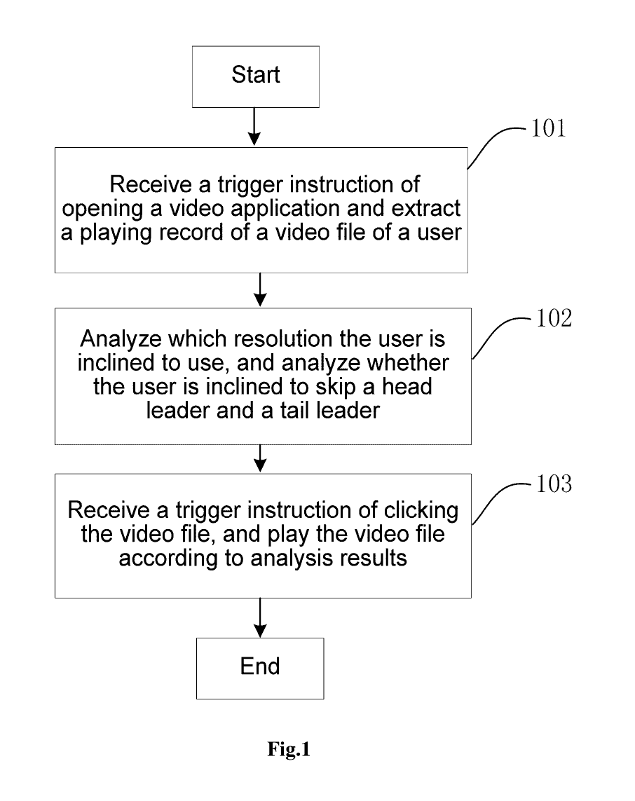

FIG. 1 is a schematic flowchart of a method for implementing quick start playing of video according to a first embodiment of the present disclosure, and the method for implementing quick start playing of video includes the following steps.

In step 101, a trigger instruction of opening a video application is received and a playing record of a video file of a user is extracted.

In the embodiment, it may be determined whether the user is logged in after the trigger instruction of opening the video application is received. If the user is not logged in, the user is logged in firstly and then the playing record of the video file of the user is extracted. If the user is already logged in, the playing record of the video file of the user is directly extracted.

In step 102, the number of times of playing the video file at each of resolutions in the playing record is calculated to analyze which resolution the user is inclined to use, and the number of times of skipping or not skipping a head leader and a tail leader in the playing record is calculated to analyze whether the user is inclined to skip the head leader and the tail leader.

As the embodiment, after the number of times of playing the video file at each of resolutions in the playing record is calculated, a resolution which is used most frequently may be directly used as a resolution which the user is inclined to use. Furthermore, the user may have a certain tendency to use resolutions in different periods. Therefore, weights may be set in sequence from large to small for time from near to far. In other words, the weight is larger as the time gets nearer to the current time, and the weight is smaller as the time gets farther away from the current time. Then, each time weight is respectively multiplied by each of resolutions corresponding to the time weight, all multiplication results corresponding to each of resolutions are added, an added result each of resolutions is calculated, and a resolution having a largest calculation result is acquired. In other words, the resolution is used as a resolution which the user is inclined to use.

For example, the weight of August is set as 30, the weight of July is set as 20, and the weight of June is set as 10. The number of times of using an ultra high-definition resolution in August is 5, the number of times of using the ultra high-definition resolution in July is 3, and the number of times of using the ultra high-definition resolution in June is 0. The number of times of using a high-definition resolution in August is 3, the number of times of using the high-definition resolution in July is 1, and the number of times of using the high-definition resolution in June is 0. A calculation result of the ultra high-definition resolution is: 30*5+20*3+10*0=210, and a calculation result of the high-definition resolution is: 30*3+20*1+10*0=110. Thus, the ultra high-definition resolution may be used as a resolution which the user is inclined to use.

Wherein, the number of times of skipping or not skipping the head leader and the tail leader in the playing record is calculated, and a condition corresponding to the larger number of times may be directly used as a condition which the user is inclined to use. Of course, a ratio of the number of times of skipping the head leader and the tail leader to the number of times of not skipping the head leader and the tail leader may be computed, and then it is determined whether the ratio exceeds a preset threshold. The user is inclined to skip the head leader and the tail leader if the ratio exceeds the preset threshold, or the user is inclined not to skip the head leader and the tail leader if the ratio does not exceed the preset threshold.

In step 103, a trigger instruction for clicking the video file is received, and the video file is played according to results of analyzing which resolution the user is inclined to use and whether the user is inclined to skip the head leader and the tail leader.

In the embodiment, after the trigger instruction of clicking the video file is received, the video file is played by using the resolution which the user is inclined to use according to an analysis result in step 102, and the video file is played according to the result of analyzing whether the head leader and the tail leader is skipped in step 102. After the trigger instruction of clicking the video file is received, it is determined whether the video file clicked exists in the playing record. If the video file clicked exists in the playing record, the playing record of the video file is extracted and the video file is played according to the playing record. If the video file clicked does not exist in the playing record, the video file is played according to results of analyzing which resolution the user is inclined to use and whether the user is inclined to skip the head leader and the tail leader. In this way, it is implemented that no matter a previously clicked video file or a newly-clicked video file can quickly start to be played.

In addition, when a video file is played by using the method for implementing quick start playing of video, a resolution of a terminal display device at the moment can be acquired, and it is determined whether the resolution of the terminal display device is matched with a resolution used to play the video file. The video file continues to be played by using the resolution if the resolution of the terminal display device is matched with the resolution used to play the video file, or the resolution used to play the video file is changed such that it is matched with the resolution of the terminal display device if the resolution of the terminal display device is not matched with the resolution used to play the video file. The changing the resolution used to play the video file such that it is matched with the resolution of the terminal display device may include matching in sequence each of resolutions with the resolution of the terminal display device until it is matched with the resolution of the terminal display device, according to a result of calculating the number of times of playing the video file at each of resolutions in the playing record. It should be explained that the number of times of playing the video file at each of resolutions in the playing record may be sorted in ascending or descending order.

For example, the number of times of playing the video file at each of resolutions in the playing record are sorted in descending order as follow: the number of times of playing the video file at the ultra high-definition resolution is eight, the number of times of playing the video file at the high-definition resolution is five, and the number of times of playing the video file at a standard-definition resolution is two. If the ultra high-definition resolution is not matched with the resolution of the terminal display device, the high-definition resolution is matched with the resolution of the terminal display device. If the high-definition resolution is also not matched with the resolution of the terminal display device, the standard-definition resolution is matched with the resolution of the terminal display device. The video file is played with the standard-definition resolution if the standard-definition resolution is matched with the resolution of the terminal display device.

It is worth noting that a user can watch a video file more comfortably and have a better watching effect if a resolution used to play the video file is matched with the resolution of the terminal display device. In addition, one reason that the resolution used to play the video file needs to be matched with the resolution of the terminal display device is that the user may log into the video application platform on different terminals, and resolutions of different terminals are different, thus the original resolution used to play the video file may be not matched with a resolution of a currently-used terminal.

As an embodiment, after the video file is played in step 103, it is determined whether code stream loss or overflow exists in the video file played. If the code stream loss or overflow exists, a code stream is reduced or increased and the video file continues to be played according to the code stream processed. If the code stream loss or overflow does not exist, the video file continues to be played according to the code stream. In other words, when a video file is played, it is detected whether the code stream loss or overflow exists in the video file played according to actual conditions of network. The code stream loss or overflow may cause that the video file cannot be played normally. Further, after the code stream loss or overflow is detected, the code stream may be automatically adjusted (reduced or increased) so that the video file can be smoothly played.

Furthermore, after the video file is played in step 103, it is also determined whether the video file played is played with a paid code stream. If yes, a user level is acquired and it is determined whether the user level is matched with the paid code stream. If the user level is matched with the paid code stream, the video file is played according to the paid code stream. If the user level is not matched with the paid code stream, the video file is played according to the paid code stream within a limited period of time, and the video file is played according to a free code stream after the limited period of time. For example, if the user level acquired is not allowed to watch a video file played with paid code stream for free, the video file may be played according to the paid code stream within the first six minutes, and may be played according to the free code stream after six minutes.

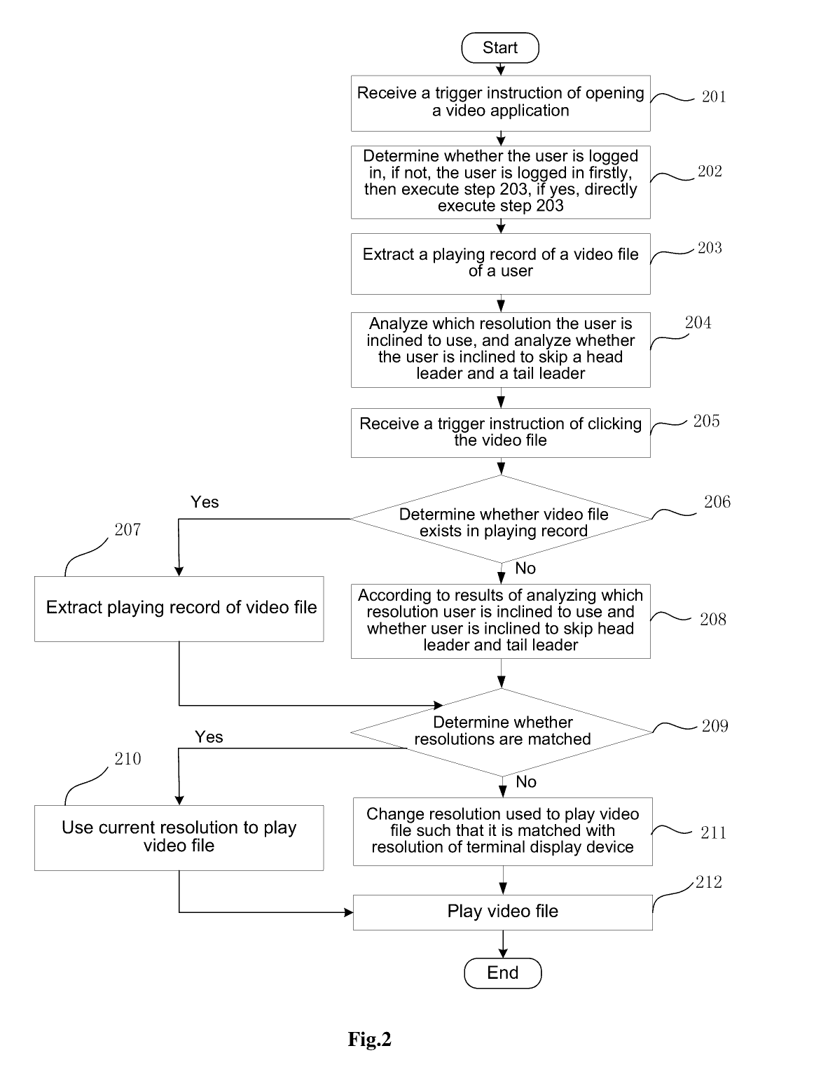

As a referable embodiment, referring to FIG. 2, the method for implementing quick start playing of video specifically may use the following steps.

In step 201, a trigger instruction of opening a video application is received.

In step 202, it is determined whether a user is logged in, if the user is not logged in, the user is logged in firstly, and then step 203 is performed, or if the user is already logged in, the step 203 is directly performed.

In step 203, a playing record of the video file of the user is extracted.

In step 204, the number of times of playing the video file at each of resolutions in the playing record is calculated to analyze which resolution the user is inclined to use, and the number of times of skipping or not skipping a head leader and a tail leader in the playing record is calculated to analyze whether the user is inclined to skip the head leader and the tail leader.

In step 205, the trigger instruction of clicking the video file is received.

In step 206, it is determined whether the video file clicked exists in the playing record; if the video file clicked exists in the playing record, step 207 is performed, or if the video file clicked does not exist in the playing record, step 208 is performed.

In step 207, the playing record of the video file is extracted, and then step 209 is performed.

In step 208, the step 209 is performed according to results of analyzing which resolution the user is inclined to use and whether the user is inclined to skip the head leader and the tail leader.

In step 209, it is determined whether the resolution of the terminal display device is matched with a resolution used to play the video file; if the terminal display device is matched with the resolution used to play the video file, step 210 is performed, or if the terminal display device is not matched with the resolution used to play the video file, step 211 is performed.

In step 210, the video file is played by using the current resolution, and the step 212 is performed.

In step 211, the resolution used to play the video file is changed such that it is matched with the resolution of the terminal display device, and the step 212 is performed.

In step 212, the video file is played.

Before the video file is played in step 212, it is also determined whether the video file played is played with a paid code stream; if yes, a user level is acquired and it is determined whether the user level is matched with the paid code stream. If the user level is matched with the paid code stream, the video file is played according to the paid code stream, or if the user level is not matched with the paid code stream, the video file is played according to the paid code stream within a limited period of time, and the video file is played according to a free code stream after the limited period of time.

As another referable embodiment, after step 212, it is also determined whether code stream loss or overflow exists in the video file played. If the code stream loss or overflow exists, the code stream is reduced or increased and the video file continues to be played according to the code stream processed. If the code stream loss or overflow does not exist, the video file continues to be played according to the code stream.

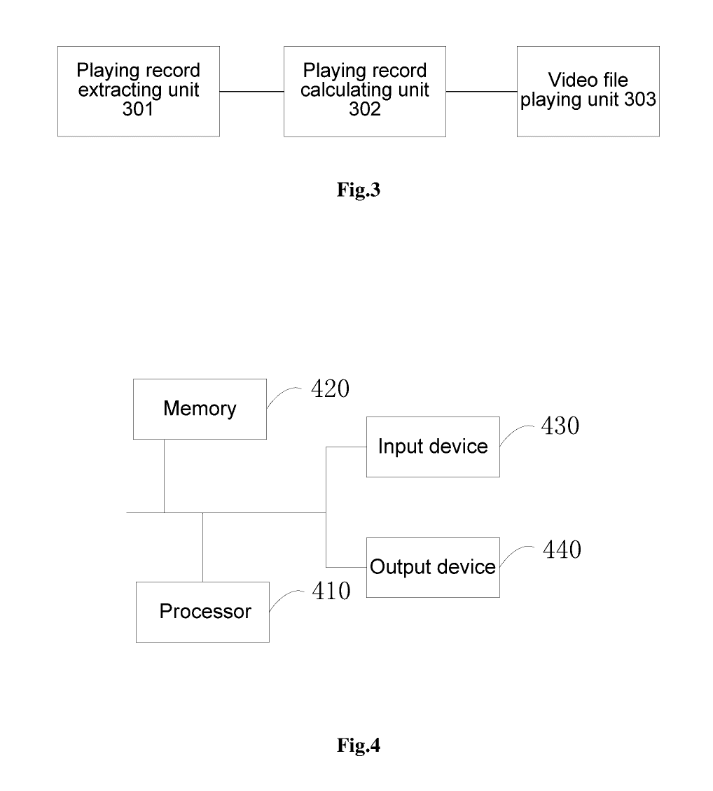

In another aspect of the present disclosure, there is further provided a system for implementing quick start playing of video. As shown in FIG. 3, the system for implementing quick start playing of video includes a playing record extracting unit 301, a playing record calculating unit 302 and a video file playing unit 303 that are connected in sequence. The playing record extracting unit 301 receives a trigger instruction of opening a video application and extracts a playing record of a video file of a user. The playing record calculating unit 302 calculates the number of times of playing the video file at each of resolutions in the playing record to analyze which resolution the user is inclined to use. The playing record calculating unit 302 calculates the number of times of skipping or not skipping a head leader and a tail leader in the playing record to analyze whether the user is inclined to skip the head leader and the tail leader. At last, the video file playing unit 303 receives a trigger instruction of clicking the video file, and plays the video file according to results of analyzing which resolution the user is inclined to use and whether the user is inclined to skip the head leader and the tail leader.

The playing record extracting unit 301 may determine whether the user is logged in after receiving the trigger instruction of opening the video application. If the user is not logged in, the user is logged in firstly, and then the playing record extracting unit 301 extracts the playing record of the video file of the user. If the user is already logged in, the playing record extracting unit 301 directly extracts the playing record of the video file of the user.

As another embodiment of the present disclosure, after calculating the number of times of playing the video file at each of resolutions in the playing record, the playing record calculating unit 302 may directly use a resolution which is used most frequently as a resolution which the user is inclined to use. Furthermore, the user may have a certain tendency to use resolutions in different periods. Therefore, weights may be set in sequence from large to small for time from near to far. In other words, the weight is larger as the time gets nearer to the current time, and the weight is smaller as the time gets farther away from the current time. Then, each time weight is respectively multiplied by each of resolutions corresponding to the time weight, and then all multiplication results corresponding to each of resolutions are added, an added result corresponding to each of resolutions are calculated, and a resolution having a largest calculation result is acquired. In other words, the resolution is used as a resolution which the user is inclined to use.

The playing record calculating unit 302 calculates the number of times of skipping or not skipping the head leader and the tail leader in the playing record, and may directly use a condition corresponding to the larger number of times as the condition which the user is inclined to use. Of course, a ratio of the number of times of skipping the head leader and the tail leader to the number of times of not skipping the head leader and the tail leader may be computed, and then it is determined whether the ratio exceeds a preset threshold. If the ratio exceeds the preset threshold, the user is inclined to skip the head leader and the tail leader, or if the ratio does not exceed the preset threshold, the user is inclined not to skip the head leader and the tail leader.

As still another referable embodiment, after receiving the trigger instruction of clicking the video file, the video file playing unit 303 may determine whether the video file clicked exists in the playing record. If the video file clicked exists in the playing record, the video file playing unit 303 extracts the playing record of the video file, and plays the video file according to the playing record. If the video file clicked does not exist in the playing record, the video file is played according to results of analyzing which resolution the user is inclined to use and whether the user is inclined to skip the head leader and the tail leader.

After playing the video file, the video file playing unit 303 may determine whether code stream loss or overflow exists in the video file played. If the code stream loss or overflow exists, the video file playing unit 303 reduces or increases a code stream, and continues to play the video file according to the code stream processed. If the code stream loss or overflow does not exist, the video file playing unit 303 continues to play the video file according to original code stream. In other words, when the video file is played, it is detected whether the code stream loss or overflow exists in the video file played according to actual conditions of network. The code stream loss or overflow may cause that the video file cannot be played normally. Further, after the code stream loss or overflow is detected, the code stream may be automatically adjusted (reduced or increased) so that the video file can be smoothly played.

In some embodiments mentioned above, the video file playing unit 303 also can determine whether the video file played is played with a paid code stream. If yes, the video file playing unit 303 acquires a user level and determines whether the user level is matched with the paid code stream. If the user level is matched with the paid code stream, the video file playing unit 303 plays the video file according to the paid code stream. If the user level is not matched with the paid code stream, the video file playing unit 303 plays the video file according to the paid code stream within a limited period of time, and plays the video file according to a free code stream after the limited period of time.

In addition, as an embodiment of the present disclosure, when playing a video file, the video file playing unit 303 can acquire a resolution of a terminal display device at the moment, and determine whether the resolution of the terminal display device is matched with a resolution used to play the video file. If the resolution of the terminal display device is matched with the resolution used to play the video file, the video file continues to be played by using the resolution, or if the resolution of the terminal display device is not matched with the resolution used to play the video file, the resolution used to play the video file is changed such that it is matched with the resolution of the terminal display device. The changing the resolution used to play the video file such that it is matched with the resolution of the terminal display device may include matching in sequence each of resolutions with the resolution of the terminal display device until it is matched with the resolution of the terminal display device, according to a result of calculating the number of times of playing the video file at each of resolutions in the playing record. It should be explained that the number of times of playing the video file at each of resolutions in the playing record may be sorted in ascending or descending order.

It should be explained that specific implementation contents of the system for implementing quick start playing of video as recited in the present disclosure have been described in detail in the method for implementing quick start playing of video as described above, and thus repeated contents thereof are not described any more.

An embodiment of the present disclosure further provide a non-volatile computer storage medium, wherein the non-volatile computer storage medium is stored with computer executable instructions which are used to perform any of the methods for implementing quick start playing of video in the above embodiments.

FIG. 4 is a schematic structure diagram of hardware of an electronic device for implementing quick start playing of video according to an embodiment of the present disclosure. As shown in FIG. 4, the device includes one or more processors 410 and a memory 420, and FIG. 4 illustrates one processor 410 as an example.

The electronic device for implementing quick start playing of video may further include an input device 430 and an output device 440.

The processor 410, memory 420, input device 430 and output device 440 may be connected with each other through bus or other ways. FIG. 4 illustrates bus connection as an example.

As a non-volatile computer readable storage medium, the memory 420 may be configured to store non-volatile software program, non-volatile computer executable program and module, such as program instruction/module corresponding to the method for implementing quick start playing of video according to the embodiments of the disclosure (for example, playing record extracting unit 301, playing record calculating unit 302 and video file playing unit 303, as illustrated in FIG. 3). By executing the non-volatile software program, instruction and module stored in the memory 420, the processor 410 may perform various functional applications of the server and data processing, that is, achieve the method for implementing quick start playing of video according to the above mentioned embodiments.

The memory 420 may include a program storage area and a data storage area, wherein the program storage area may store the operating system and application which are needed by at least one function, and the data storage area may store data which is created according to use of the device for implementing quick start playing of video, and the like. Further, the memory 420 may include a high-speed random access memory, and may further include a non-volatile memory, such as at least one of disk memory device, flash memory device or other types of non-volatile solid state memory device. In some embodiments, optionally, the memory 420 may include a memory provided remotely with respect to the processor 410, and such memory may be connected with the device for implementing quick start playing of video through network. The examples of the network may include but not limited to Internet, intranet, LAN (Local Area Network), mobile communication network and combinations thereof.

The input device 430 may receive inputted digital or character information, and generate key signal input related to the user settings and functional control of the device for implementing quick start playing of video. The output device 440 may include a display device such as a display screen and the like.

The above one or more modules may be stored in the memory 420. When these modules are executed by the one or more processor 410, the method for implementing quick start playing of video according to any one of the above embodiments may be performed.

The above product may perform the methods provided in the embodiments of the disclosure, and include functional modules corresponding to these methods and advantageous effects. Further technical details which are not described in detail in the present embodiment may refer to the methods provided according to embodiments of the disclosure.

The electronic device in the embodiment of the present disclosure may be embodied in various forms, including but not limited to:

(1) mobile communication device, characterized in having a function of mobile communication and mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID, UMPC devices and the like, such as iPad;

(3) portable entertainment device, which can display and play multimedia contents, and includes audio or video player (such as iPod), portable game console, e-book and smart toys and portable vehicle navigation device;

(4) server, which is an device for providing computing service, and constituted by processor, hard disc, memory, system bus and the like, wherein the server has a framework similar to that of a computer, but is demanded for superior processing ability, stability, reliability, security, extendibility and manageability due to high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in a place or distributed to a plurality of network units. All or part of modules may be selected as actually required to implement the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk, compact disc and the like, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

1. A method for implementing quick start playing of video, which is applied to an electronic device, comprising:
receiving a trigger instruction of opening a video application, and extracting a playing record of a video file of a user;
calculating the number of times of playing the video file at each of resolutions in the playing record to analyze which resolution the user is inclined to use; and calculating the number of times of skipping or not skipping a head leader and a tail leader in the playing record to analyze whether the user is inclined to skip the head leader and the tail leader; and
receiving a trigger instruction of clicking the video file, and playing the video file according to results of analyzing which resolution the user is inclined to use and whether the user is inclined to skip the head leader and the tail leader.

2. The method according to claim 1, wherein, after playing the video file, the method further comprising:
determining whether code stream loss or overflow exists in the video file played; and
according to a determination result, if the code stream loss or overflow exists, reducing or increasing a code stream and continuing to play the video file according to the code stream processed, or if the code stream loss or overflow does not exist, continuing to play the video file according to the code stream.

3. The method according to claim 1, wherein, after receiving the trigger instruction of clicking the video file, the method further comprising:
determining whether the video file clicked exists in the playing record; and
according to a determination result, if the video file exists in the playing record, extracting the playing record of the video file and playing the video file according to the playing record, or if the video file does not exist in the playing record, playing the video file according to results of analyzing which resolution the user is inclined to use and whether the user is inclined to skip the head leader and the tail leader.

4. The method according to claim 3, wherein, after playing the video file, the method further comprising:
acquiring a resolution of a terminal display device at the moment; and
determining whether the resolution of the terminal display device is matched with a resolution used to play the video file, and continuing to play the video file by using the resolution if the resolution of the terminal display device is matched with the resolution used to play the video file, or changing the resolution used to play the video file such that the resolution used to play the video file is matched with the resolution of the terminal display device if the resolution of the terminal display device is not matched with the resolution used to play the video file.

5. The method according to claim 4, wherein, the changing the resolution used to play the video file such that the resolution used to play the video file is matched with the resolution of the terminal display device comprises:
according to a result of calculating the number of times of playing the video file at each of resolutions in the playing record, matching in sequence each of resolutions with the resolution of the terminal display device until it is matched with the resolution of the terminal display device.

6. The method according to claim 1, wherein, the calculating the number of times of playing the video file at each of resolutions in the playing record to analyze which resolution the user is inclined to use comprises:
setting in sequence weights from large to small according to time from near to far, multiplying each time weight by the number of times of playing the video file at each of resolutions in the playing record corresponding to the time, respectively, and then adding all multiplication results corresponding to each of resolutions, calculating an added result corresponding to each of resolutions, and acquiring a resolution having a largest calculation result; and
the calculating the number of times of skipping or not skipping the head leader and the tail leader in the playing record to analyze whether the user is inclined to skip the head leader and the tail leader comprises: computing a ratio of the number of times of skipping the head leader and the tail leader to the number of times of not skipping the head leader and the tail leader, and determining whether the ratio exceeds a preset threshold, wherein the user is inclined to skip the head leader and the tail leader if the ratio exceeds the preset threshold, or the user is inclined not to skip the head leader and the tail leader if the ratio does not exceed the preset threshold.

7. The method according to claim 1, wherein, when playing the video file, the method further comprises:
if the video file played is played with a paid code stream, acquiring a user level and determining whether the user level is matched with the paid code stream, and if the user level is matched with the paid code stream, playing the video file according to the paid code stream, or if the user level is not matched with the paid code stream, playing the video file according to the paid code stream within a limited period of time, and playing the video file according to a free code stream after the limited period of time.

8. A non-transitory computer-readable storage medium storing executable instructions that, when executed by an electronic device with a touch-sensitive display, cause the electronic device to:
receive a trigger instruction of opening a video application, and extract a playing record of a video file of a user;
calculate the number of times of playing the video file at each of resolutions in the playing record to analyze which resolution the user is inclined to use; and calculate the number of times of skipping or not skipping a head leader and a tail leader in the playing record to analyze whether the user is inclined to skip the head leader and the tail leader; and
receive a trigger instruction of clicking the video file, and play the video file according to results of analyzing which resolution the user is inclined to use and whether the user is inclined to skip the head leader and the tail leader.

9. The non-transitory computer-readable storage medium according to claim 8, wherein, after the video file is played, the electronic device is further caused to:
determine whether code stream loss or overflow exists in the video file played; and
according to a determination result, if the code stream loss or overflow exists, reduce or increase a code stream and continue to play the video file according to the code stream processed, or if the code stream loss or overflow does not exist, continue to play the video file according to the code stream.

10. The non-transitory computer-readable storage medium according to claim 8, wherein, after the trigger instruction of clicking the video file is received, the electronic device is further caused to:
determine whether the video file clicked exists in the playing record; and
according to a determination result, if the video file exists in the playing record, extract the playing record of the video file and play the video file according to the playing record, or if the video file does not exist in the playing record, play the video file according to results of analyzing which resolution the user is inclined to use and whether the user is inclined to skip the head leader and the tail leader.

11. The non-transitory computer-readable storage medium according to claim 10, wherein, after the video file is played, the electronic device is further caused to:
acquire a resolution of a terminal display device at the moment; and
determine whether the resolution of the terminal display device is matched with a resolution used to play the video file, and continue to play the video file by using the resolution if the resolution of the terminal display device is matched with the resolution used to play the video file, or change the resolution used to play the video file such that the resolution used to play the video file is matched with the resolution of the terminal display device if the resolution of the terminal display device is not matched with the resolution used to play the video file.

12. The non-transitory computer-readable storage medium according to claim 8, wherein, the calculating the number of times of playing the video file at each of resolutions in the playing record to analyze which resolution the user is inclined to use comprises:
setting in sequence weights from large to small according to time from near to far, multiplying each time weight by the number of times of playing the video file at each of resolutions in the playing record corresponding to the time, respectively, and then adding all multiplication results corresponding to each of resolutions, calculating an added result corresponding to each of resolutions, and acquiring a resolution having a largest calculation result; and
the calculating the number of times of skipping or not skipping the head leader and the tail leader in the playing record to analyze whether the user is inclined to skip the head leader and the tail leader comprises: computing a ratio of the number of times of skipping the head leader and the tail leader to the number of times of not skipping the head leader and the tail leader, and determining whether the ratio exceeds a preset threshold, wherein the user is inclined to skip the head leader and the tail leader if the ratio exceeds the preset threshold, or the user is inclined not to skip the head leader and the tail leader if the ratio does not exceed the preset threshold.

13. The non-transitory computer-readable storage medium according to claim 8, wherein, when the video file is played, the electronic device is further caused to:
if the video file played is played with a paid code stream, acquire a user level and determine whether the user level is matched with the paid code stream, and if the user level is matched with the paid code stream, play the video file according to the paid code stream, or if the user level is not matched with the paid code stream, play the video file according to the paid code stream within a limited period of time, and play the video file according to a free code stream after the limited period of time.

14. An electronic device, comprising:
at least one processor; and
a memory communicably connected with the at least one processor for storing instructions executable by the at least one processor, wherein execution of the instructions by the at least one processor causes the at least one processor to:
receive a trigger instruction of opening a video application, and extract a playing record of a video file of a user;
calculate the number of times of playing the video file at each of resolutions in the playing record to analyze which resolution the user is inclined to use; and calculate the number of times of skipping or not skipping a head leader and a tail leader in the playing record to analyze whether the user is inclined to skip the head leader and the tail leader; and
receive a trigger instruction of clicking the video file, and play the video file according to results of analyzing which resolution the user is inclined to use and whether the user is inclined to skip the head leader and the tail leader.

15. The electronic device according to claim 14, wherein, after the video file is played, the at least one processor is further caused to:
determine whether code stream loss or overflow exists in the video file played; and
according to a determination result, if the code stream loss or overflow exists, reduce or increase a code stream and continue to play the video file according to the code stream processed, or if the code stream loss or overflow does not exist, continue to play the video file according to the code stream.

16. The electronic device according to claim 14, wherein, after the trigger instruction of clicking the video file is received, the at least one processor is further caused to:
determine whether the video file clicked exists in the playing record; and
according to a determination result, if the video file exists in the playing record, extract the playing record of the video file and play the video file according to the playing record, or if the video file does not exist in the playing record, play the video file according to results of analyzing which resolution the user is inclined to use and whether the user is inclined to skip the head leader and the tail leader.

17. The electronic device according to claim 16, wherein, after the video file is played, the at least one processor is further caused to:
acquire a resolution of a terminal display device at the moment; and
determine whether the resolution of the terminal display device is matched with a resolution used to play the video file, and continue to play the video file by using the resolution if the resolution of the terminal display device is matched with the resolution used to play the video file, or change the resolution used to play the video file such that the resolution used to play the video file is matched with the resolution of the terminal display device if the resolution of the terminal display device is not matched with the resolution used to play the video file.

18. The electronic device according to claim 17, wherein, the changing the resolution used to play the video file such that the resolution used to play the video file is matched with the resolution of the terminal display device comprises:
according to a result of calculating the number of times of playing the video file at each of resolutions in the playing record, matching in sequence each of resolutions with the resolution of the terminal display device until it is matched with the resolution of the terminal display device.

19. The electronic device according to claim 14, wherein, the calculating the number of times of playing the video file at each of resolutions in the playing record to analyze which resolution the user is inclined to use comprises:
setting in sequence weights from large to small according to time from near to far, multiplying each time weight by the number of times of playing the video file at each of resolutions in the playing record corresponding to the time, respectively, and then adding all multiplication results corresponding to each of resolutions, calculating an added result corresponding to each of resolutions, and acquiring a resolution having a largest calculation result; and
the calculating the number of times of skipping or not skipping the head leader and the tail leader in the playing record to analyze whether the user is inclined to skip the head leader and the tail leader comprises: computing a ratio of the number of times of skipping the head leader and the tail leader to the number of times of not skipping the head leader and the tail leader, and determining whether the ratio exceeds a preset threshold, wherein the user is inclined to skip the head leader and the tail leader if the ratio exceeds the preset threshold, or the user is inclined not to skip the head leader and the tail leader if the ratio does not exceed the preset threshold.

20. The electronic device according to claim 14, wherein, when the video file is played, the at least one processor is further caused to:
if the video file played is played with a paid code stream, acquire a user level and determine whether the user level is matched with the paid code stream, and if the user level is matched with the paid code stream, play the video file according to the paid code stream, or if the user level is not matched with the paid code stream, play the video file according to the paid code stream within a limited period of time, and play the video file according to a free code stream after the limited period of time.
